(19) United States
(12) Patent Application Publication
(10) Pub. No.: US 2024/0372252 A1
(43) Pub. Date: Nov. 7, 2024

(54) PHASE SHIFT ASSEMBLY

(71) Applicants: PROSE TECHNOLOGIES (SUZHOU) CO., LTD., Suzhou (CN); PROSE TECHNOLOGIES LLC, Mount Olive, NJ (US)

(72) Inventors: Youfang HUANGFU, Suzhou (CN); Suyang BAO, Suzhou (CN); Min SHEN, Suzhou (CN); Zhonghao ZOU, Suzhou (CN)

(21) Appl. No.: 18/775,889

(22) Filed: Jul. 17, 2024

Related U.S. Application Data
(63) Continuation of application No. PCT/CN2022/140549, filed on Dec. 21, 2022.

(30) Foreign Application Priority Data
Jan. 28, 2022 (CN) 202210105627.8

(51) Int. Cl. H01Q 3/32; H01Q 3/12

(52) U.S. Cl. CPC H01Q 3/32; H01Q 3/12

(57) ABSTRACT

The present disclosure provides a phase-shifting assembly, including an antenna phase shifter and a drive apparatus. The antenna phase shifter includes at least one first phase-shifting fixed unit, at least one first phase-shifting movable unit, and at least one first phase-shifting rotation mechanism. The drive apparatus includes a power mechanism configured to provide a drive force to the antenna phase shifter, a first rotation member connected to the power mechanism and coupled to the at least one first phase-shifting rotation mechanism, and a position-limiting member configured to limit the movement of the first phase-shifting rotation mechanism in an axial direction of the first phase-shifting rotation mechanism. The first rotation member transfers the drive force of the power mechanism to the first phase-shifting rotation mechanism through the first rotation member to control a relative movement between a fixed phase-shifting trace and a first movable phase-shifting trace.

### CROSS-REFERENCES TO RELATED APPLICATIONS

The present disclosure is a continuation of International Application No. PCT/CN2022/140549, filed on Dec. 21, 2022, which claims priority to Chinese Application No. 202210105627.8 filed on Jan. 28, 2022, the entire content of all of which are incorporated herein by reference.

### TECHNICAL FIELD

The present disclosure generally relates to the communication technology field and, more particularly, to a phase-shifting assembly.

### BACKGROUND

A large number of base stations are provided in a mobile communication system. Each base station includes one or more base station antennas. A base station antenna includes a plurality of radiation units (i.e., antenna units). Due to the requirement of the coverage or optimization of the mobile communication networks, a pitch orientation of an antenna wave beam generated by the base station antenna can be adjustable (e.g., realized by a phase shifter in the base station antenna). The antenna phase shifter can be configured to adjust the phase of a component of a radio frequency (RF) signal that is transmitted or received through the antenna unit array. By changing a phase distribution of the component of the RF signal that is transmitted or received by the antenna units of the array antenna, a downward tilt angle of the antenna beam can be adjusted.

In the existing base station antenna, a transmission apparatus applied to the antenna phase shifter is an important member, which is very important for the structure and reliability of the product. In product cost, the cost of the transmission apparatus takes a considerable ratio.

The existing transmission apparatus usually translates to input power to drive the antenna phase shifter. Thus, a translation member of the transmission apparatus takes up a large space, which causes insufficient space for the antenna. In addition, the transmission member further includes a translation adapter. The manufacturing and matching tolerance cause an output error accumulation.

### SUMMARY

One aspect of the present disclosure provides a phase shifter assembly, including:
an antenna phase shifter including:
   at least one first phase-shifting fixed unit having a first fixed phase-shifting trace;
   at least one first phase-shifting movable unit having a first movable phase-shifting trace, the first fixed phase-shifting trace and the first movable phase-shifting trace being in contact with each other; and
   at least one first phase-shifting rotation mechanism, each coupled to one of the at least one first phase-shifting movable unit and configured to control a relative movement between the first fixed phase-shifting trace and the first movable phase-shifting trace; and
a drive apparatus including:
   a power mechanism configured to provide a drive force to the antenna phase shifter;
   a first rotation member connected to the power mechanism and coupled to the at least one first phase-shifting rotation mechanism; and
   a position-limiting member configured to limit a movement of the first phase-shifting rotation mechanism in an axial direction of the first phase-shifting rotation mechanism;
wherein the first rotation member transfers the drive force of the power mechanism to the first phase-shifting rotation mechanism to control a relative movement between the first fixed phase-shifting trace and the first movable phase-shifting trace.

In some embodiments, the first phase-shifting movable unit is integrally formed with the first phase-shifting rotation mechanism.

In some embodiments, when the power mechanism drives the first rotation member to rotate, the position-limiting member is further configured to limit a movement of a first part of the first rotation member in an axial direction of the first rotation member.

In some embodiments, the antenna phase shifter includes two first phase-shifting rotation mechanisms arranged in a same plane, the first rotation member is arranged between the two first phase-shifting rotation mechanisms and coupled to the two first phase-shifting rotation mechanisms, respectively, and a part of each first phase-shifting rotation mechanism is arranged in the position-limiting member.

In some embodiments, the first part of the first rotation member is an double-start worm, the antenna phase shifter includes two first phase-shifting rotation mechanisms symmetrically arranged in a same plane, and each first phase-shifting rotation mechanism includes a gear member to cause the first part of the first rotation member to respectively mesh with gear members of the two first phase-shifting rotation mechanisms.

In some embodiments, the first part of the first rotation member is a single-start worm:
the antenna phase shifter includes two first-phase-shifting rotation mechanisms arranged in a same plane; and
each first phase-shifting rotation mechanism includes a gear member;
wherein the gear members of the two first phase-shifting rotation mechanisms are offset by n+1/2 tooth pitches, n being an integer equal to or greater than 0, to cause the first part of the first rotation member to respectively mesh with the gear members of the two first phase-shifting rotation mechanisms.

In some embodiments, the antenna phase shifter also includes a first number of second phase-shifting fixed units, a first number of second phase-shifting movable units, and a first number of second phase-shifting rotation mechanisms arranged at an interval with the first phase-shifting fixed unit along an axial direction of the first phase-shifting fixed unit, the drive apparatus further includes:
a first number of second rotation members each coupled to one of the second phase-shifting rotation mechanisms;
a first transmission part connected to the first rotation member;
a first number of second transmission parts, each second transmission part being connected to a corresponding second rotation member, and each second transmission part being coupled to at least one of the first transmission part or a neighboring second transmission part; and
a first number of second position-limiting members, each second position-limiting member being configured to limit a movement of a corresponding second phase-shifting rotation mechanism in an axial direction of the second phase-shifting rotation mechanism, and a part of the second phase-shifting rotation mechanism being arranged in the second position-limiting member;
wherein:
   when the power mechanism drives the first rotation member to rotate, the power mechanism controls a relative movement between the first phase-shifting fixed unit and the first phase-shifting movable unit and a relative movement between the corresponding second phase-shifting fixed unit and the second phase-shifting movable unit through a coupled movement of the first transmission part and the second transmission part; and
   when the first number is greater than or equal to 2, a relative movement between the corresponding second phase-shifting fixed unit and the second phase-shifting movable unit is controlled through a coupled movement of two neighboring second transmission parts.

In some embodiments, when the power mechanism drives the second rotation member to rotate, the second position-limiting member is further configured to limit a movement of the first part of the second rotation member in an axial direction of the second rotation member.

In some embodiments, the first part of the first rotation member is a worm gear structure with a first helical direction;
a first part of the second rotation member neighboring to the first rotation member is a worm gear structure with a helical direction opposite to the first helical direction;
when the first number is greater than or equal to 2, first parts of the two neighboring second rotation members have worm gear structures with opposite helical directions;
the first phase-shifting rotation mechanism includes a first gear member, and the second phase-shifting rotation member includes a second gear member; and
the first part of the first rotation member meshes with the first gear member, and the first part of the second rotation member meshes with the second gear member of the second phase-shifting rotation mechanism.

In some embodiments, the antenna phase shifter further includes a first number of second phase-shifting fixed units, the first number of second phase-shifting movable units, and a second phase-shifting rotation mechanism arranged at intervals with the first phase-shifting fixed unit along an axial direction of the first phase-shifting fixed unit, the drive apparatus further includes: the first number of second rotation members each coupled to one of the second phase-shifting mechanisms;
a first transmission part connected to the first rotation member;
the first number of second transmission parts, each second transmission part being connected to a corresponding second rotation member;
at least one third transmission part arranged between the first transmission part and the second transmission part to cause the first rotation member and the corresponding second rotation member to have a same rotation direction, or between two neighboring second transmission parts to cause the two neighboring rotation members to have a same rotation direction; and
the first number of second position-limiting members, each second position-limiting member being configured to limit a movement of the corresponding second phase-shifting rotation mechanism in an axial direction of the second phase-shifting rotation mechanism, a part of the second phase-shifting rotation mechanism being arranged in the second position-limiting member;
wherein:
when the power mechanism drives the first rotation member to rotate, the power mechanism controls a relative movement between the first phase-shifting fixed unit and the first phase-shifting movable unit and a relative movement between the corresponding second phase-shifting fixed unit and the second phase-shifting movable unit; and
when the first number is greater than or equal to 2, a relative movement between the corresponding second phase-shifting fixed unit and the second phase-shifting movable unit is controlled by a coupled movement between two neighboring second transmission parts and the third transmission part between the two neighboring second transmission parts.

In some embodiments, the first part of the first rotation member and a first part of the second rotation member include worm gear structures with a same helical direction; and
the first phase-shifting rotation mechanism includes a first gear member, and a second phase-shifting rotation mechanism includes a second gear member;
the first part of the first rotation member meshes with the first gear member, and the first part of the second rotation member meshes with the second gear member.

In some embodiments, each second phase-shifting fixed unit includes a second fixed phase-shifting trace, each second phase-shifting fixed unit includes a second movable phase-shifting trace, and each second phase-shifting rotation mechanism is configured to control a relative movement between the corresponding second fixed phase-shifting trace and the corresponding second movable phase-shifting trace.

In some embodiments, the second phase-shifting movable unit is integrally formed with the corresponding second phase rotation mechanism, and/or the first phase-shifting movable unit is integrally formed with the first phase-shifting rotation mechanism.

In some embodiments, when the antenna phase shifter further includes a first number of second phase-shifting fixed units, the first number of second phase-shifting movable units, and the first number of second phase-shifting rotation mechanisms:
when the first number=1, the drive apparatus further includes:
   a first drive element connected to a corresponding first phase-shifting rotation mechanism and a second phase-shifting rotation mechanism;
   wherein the first rotation member transfers a drive force of the power mechanism to the at least first phase-shifting rotation mechanism to control a relative movement between the corresponding first phase-shifting fixed unit and the first phase-shifting movable unit, and the first drive element controls the relative movement between the corresponding second phase-shifting fixed unit and the second phase-shifting movable unit by driving the second phase-shifting rotation mechanism directly or indirectly; and when the first number is greater than or equal to 2, the drive apparatus further includes:
   the first drive element connected to the corresponding first phase-shifting rotation mechanism and the corresponding second phase-shifting rotation mechanism; and
   at least one second drive element connected between two neighboring second phase-shifting fixed units;
   wherein when the first rotation member transfers the driving force of the power mechanism to the at least one first phase-shifting rotation mechanism to control the relative movement between the first phase-shifting fixed unit and the first phase-shifting movable unit, the first drive element and the second drive element drive corresponding second phase-shifting rotation mechanisms, respectively, to control a relative movement between the corresponding second phase-shifting fixed unit and the second phase-shifting movable unit.

In some embodiments, each second phase-shifting fixed unit includes a second fixed phase-shifting trace, and each second phase-shifting fixed unit includes a second movable phase-shifting trace, and each second phase-shifting rotation mechanism is configured to control a relative movement between the corresponding second fixed phase-shifting trace and the second movable phase-shifting trace.

In some embodiments, the second phase-shifting movable unit is integrally formed with the corresponding second phase-shifting rotation mechanism; and/or the first phase-shifting movable unit is integrally formed with the first phase-shifting rotation mechanism.

In some embodiments, the position-limiting member or the second position-limiting member includes:
a first position-limiting structure including a first end and a second end parallel to each other, and a sidewall perpendicular to the first end and the second end;
a second position-limiting structure arranged under the first position-limiting structure;
wherein the first part of the first rotation member or the first part of the second rotation member is arranged within the first position-limiting structure, and
a part of the first phase-shifting rotation mechanism is arranged between the first position-limiting structure and the second position-limiting structure to cause the first part of the first rotation member to mesh with the part of the first phase-shifting rotation mechanism; or a part of the second phase-shifting rotation mechanism is arranged between the first position-limiting structure and the second position-limiting structure to cause the first part of the second rotation member to mesh with the part of the second phase-shifting rotation mechanism.

In some embodiments, the first end of the first position-limiting structure includes a first installation hole, and the first part of the first rotation member is fixed within the first position-limiting structure through the first installation hole.

In some embodiments, the sidewall of the first position-limiting structure also includes a hollow structure configured to enhance elasticity of a protrusion.

In some embodiments, the sidewall includes a protrusion, and the protrusion is aligned with the second position-limiting structure in parallel to arrange a part of the first phase-shifting rotation mechanism or a part of the second phase-shifting rotation mechanism between the second position-limiting structure with a pair of protrusions.

In some embodiments, the position-limiting member includes:
a first position-limiting structure including a first end and a second end that are parallel to each other, and a sidewall perpendicular to the first end and the second end;
wherein:
   the first end includes a first installation hole to cause the first part of the first rotation member to be fixed in the first position-limiting structure through the first installation hole; and
   the sidewall includes a protrusion aligned with a second position-limiting structure in parallel to cause a part of the first phase-shifting rotation mechanism to be arranged between the second position-limiting structures with the pair of protrusions.

According to the phase-shifting assembly of the present disclosure, the antenna phase shifter can be driven by a rotation input. Thus, when the antenna phase shifter adjusts the phase, the overall volume of the phase-shifting assembly can be reduced, which lowers the difficulty in the antenna structural layout. In the technical solution of the present disclosure, since the worm gear-helical gear transmission structure is adopted, the directions of the input and output power can be changed. The axial direction of the phase-shifting rotation mechanism can be eliminated for the position-limiting member to ensure the transmission precision.

### BRIEF DESCRIPTION OF THE DRAWINGS

Embodiments are shown and described with reference to the drawings. The drawings are used to illustrate the basic principles. Thus, only aspects necessary for understanding the basic principles are shown. The accompanying drawings are not according to scales. In the accompanying drawings, identical reference numbers indicate similar features.

FIG. 1 is a schematic whole structural diagram of a phase shafting assembly according to some embodiments of the present disclosure.

FIG. 2 is a schematic divided structural diagram of a whole phase shafting assembly according to some embodiments of the present disclosure.

FIG. 2A is a schematic structural diagram of a phase-shifting movable unit of a phase-shifting assembly according to some embodiments of the present disclosure.

FIG. 3A and FIG. 3B are schematic diagrams of a position-limiting member according to some embodiments of the present disclosure.

FIG. 4 is a schematic whole structural diagram of a phase-shifting assembly according to some embodiments of the present disclosure.

FIG. 5 is a schematic whole structural diagram of another phase-shifting assembly according to some embodiments of the present disclosure.

FIG. 6 is a schematic whole structural diagram of a phase-shifting assembly according to some embodiments of the present disclosure.

FIG. 7 is a schematic whole structural diagram of another phase-shifting assembly according to some embodiments of the present disclosure.

FIG. 8 is a schematic whole structural diagram of a phase-shifting assembly according to some embodiments of the present disclosure.

FIG. 9 is a schematic whole structural diagram of another phase-shifting assembly according to some embodiments of the present disclosure

### DETAILED DESCRIPTION OF THE EMBODIMENTS

Embodiments of the present disclosure are described in connection with the accompanying drawings that form a part of the present disclosure. The accompanying drawings illustrate some embodiments of the present disclosure by examples. Exemplary embodiments are not intended to exhaustively represent all embodiments of the present disclosure. Other embodiments can be used, and structural or logical modifications can be made without departing from the scope of the present disclosure. Thus, the following description below is not restrictive, and the scope of the present disclosure is defined by the appended claims.

In the present disclosure, “include,” “comprise,” and similar terms should be understood as open terms, i.e., “including but not limited to,” indicating that other contents can be included. The term “based on” is “at least partially based on.” The term “an embodiment” indicates “at least one embodiment.” The term “another embodiment” indicates “at least one additional embodiment.”

The technical problem to be solved by the present disclosure is how to reduce the size of a phase-shifting assembly, improve transmission precision, and lower a manufacturing cost of the phase-shifting assembly.

To solve the technical problem, the phase-shifting assembly of the present disclosure can include an antenna phase shifter and a drive apparatus. In some embodiments, the antenna phase shifter can include at least one first phase-shifting fixed unit, at least one first phase-shifting movable unit, and at least one first phase-shifting rotation mechanism. The drive mechanism can include a power mechanism configured to provide a driving force to the antenna phase shifter, a first rotation member connected to the power mechanism and coupled to the at least one first phase-shifting rotation mechanism, and a position-limiting member configured to limit the axial movement of the first phase-shifting rotation mechanism. The first rotation member can be configured to transfer the driving force of the power mechanism to the first phase-shifting rotation mechanism through the first rotation member to control the relative movement between the first phase-shifting fixed unit and the first phase-shifting movable unit.

### Embodiment 1

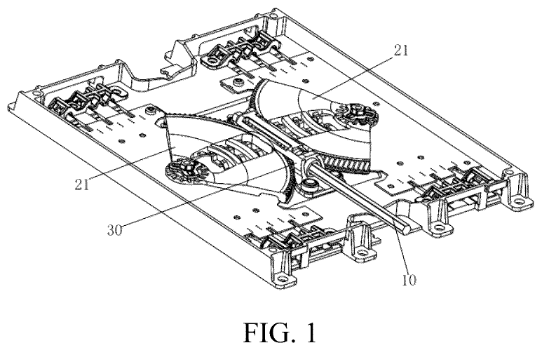

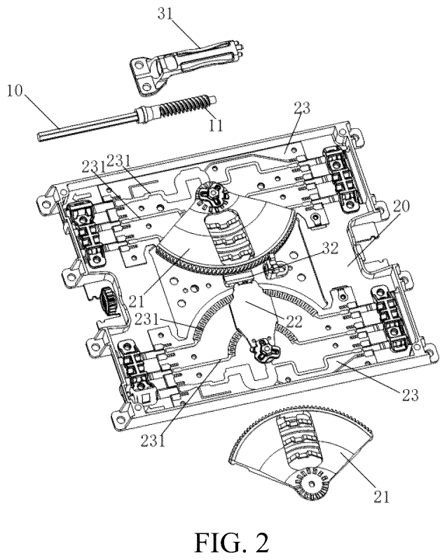

As shown in FIG. 1, FIG. 2, and FIG. 2a, an example of the phase-shifting assembly of the present disclosure is provided. In some embodiments, the phase-shifting assembly includes an antenna phase shifter and a drive apparatus. In some embodiments, the antenna phase shifter includes a pair of first phase-shifting rotation mechanisms 21, a pair of first phase-shifting movable units 22, and a pair of first phase-shifting fixed units 23 arranged on a same plane. The pair of first phase-shifting fixed units 23 are arranged at a housing 20 of the antenna phase shifter. The pair of first phase-shifting movable units 22 are arranged at the corresponding first phase-shifting rotation mechanisms 21, respectively. A first phase-shifting fixed unit 23 includes a first fixed phase-shifting trace 231. The drive apparatus includes a power mechanism (not shown in the figure) configured to provide the drive force for the antenna phase shifter, a first rotation member 10 connected to the power mechanism, and a position-limiting member 30.

In some embodiments, the first rotation member 10 can be coupled to the at least one first phase-shifting rotation mechanism 21. Thus, the first rotation member 10 can transfer the driving force of the power mechanism to the first phase-shifting rotation mechanism 21 to drive the first phase-shifting rotation mechanism 21 to move. Meanwhile, the movement of the first phase-shifting rotation mechanism 21 can be used to control the first phase-shifting movable unit 22 to rotate relative to the first phase-shifting fixed unit 23. Thus, the a contact position of a first movable phase-shifting trace 221 of the first phase-shifting movable unit 22 and the first fixed phase-shifting trace 231 of the first phase-shifting fixed unit 23 can change to change the phase of the external output signal.

Additionally, in practical applications, the first phase-shifting rotation mechanism 21 can also be integrally formed with the corresponding first phase-shifting movable unit 22.

In some embodiments, a part of the first phase-shifting rotation mechanism 21 and a first part 11 of the first rotation member 10 can be coupled and arranged in the position-limiting member 30. When the power mechanism drives the first rotation member 10 to rotate, the position-limiting member 30 can be configured to limit the rotation of the first phase-shifting rotation mechanism 21 in the axial direction of the first phase-shifting rotation mechanism 21 and limit the axial position of the first part 11 of the first rotation member 10 to ensure that the first part 11 of the first rotation member 10 can stably drive the first phase-shifting rotation mechanism 21 to move.

As shown in FIGS. 1 and 2, in embodiments of the present disclosure, the first rotation member 10 is arranged between and coupled to the two first phase-shifting rotation mechanisms 21. A part of each first phase-shifting rotation mechanism 21 and the first part 11 of the first rotation member 10 are arranged within the position-limiting member 30.

In some embodiments, the first part 11 of the first rotation member 10 can be a worm gear structure. An edge of the first phase-shifting rotation mechanism 21 can include a gear member. Thus, the first part 11 of the first rotation member 10 can mesh with the gear member of the first phase-shifting rotation mechanism 21.

In some embodiments, the gear member of the first phase-shifting rotation mechanism 21 can be a helical gear. Thus, the transmission between the first rotation member 10 and the first phase-shifting rotation mechanism 21 can be a worm gear-helical gear transmission. When the worm gear drives the first phase-shifting rotation mechanism 21 to rotate, the gear member of the first phase-shifting rotation mechanism 21 can experience a lateral force. The direction of the lateral force can point toward the housing 20 of the antenna phase shifter or toward a side of the first phase-shifting rotation mechanism 21 away from the housing 20 of the antenna phase shifter. When the lateral force points to the side of the first phase-shifting rotation mechanism 21 away from the housing 20 of the antenna phase shifter, the first phase-shifting rotation mechanism 21 can move away from the housing 20 of the antenna phase shifter under the lateral force to cause poor contact between the first phase-shifting movable unit 22 and the first phase-shifting fixed unit 23. Since the position-limiting member 30 is arranged to offset the lateral force, a reliable contact between the first phase-shifting movable unit 22 and the first phase-shifting fixed unit 23 can be ensured.

In some embodiments, although the part of the first phase-shifting rotation mechanism 21 and the first part 11 of the first rotation member 10 are arranged within the position-limiting member 30, it can be understood that the first part 11 of the first rotation member 10 may not necessarily be arranged within the position-limiting member 30. In some embodiments, the part of the first phase-shifting rotation mechanism 21 and the first part 11 of the first rotation member 10 can be arranged within the position-limiting member 30, and the position-limiting member 30 can offset the lateral force received by the first phase-shifting rotation mechanism 21 and also support the first rotation member 10 to save material and space.

Further, the first part 11 of the first rotation member 10 can be an double-start worm or a single-start worm.

When the first part 11 of the first rotation member 10 is an double-start worm, the two first phase-shifting rotation mechanisms 21 on the same plane can be symmetrically arranged. Thus, the first part 11 of the first rotation member 10 can mesh with the gear members of the both first phase-shifting rotation mechanisms 21 to ensure that the two first phase-shifting rotation mechanisms 21 can rotate simultaneously.

When the first part 11 of the first rotation member 10 is a single-start worm, the gear members of the two first phase-shifting rotation mechanisms 21 on the same plane can offset by n+1/2 tooth pitches (n=0, 1, 2, . . . ). Thus, the first part 11 of the first rotation member 10 can mesh with the gear members of the two first phase-shifting rotation mechanisms 21 to ensure that the two first phase-shifting rotation mechanisms 21 can rotate simultaneously.

In some embodiments, when the power mechanism drives the first rotation member 10 to rotate, the first part 11 (e.g., a worm gear structure) can mesh with the gear member of the first phase-shifting rotation mechanism 21 to drive the first phase-shifting rotation mechanism 21 to rotate about a center of the first phase-shifting rotation mechanism 21. Thus, the relative movement between the first fixed phase-shifting trace 231 and the first movable phase-shifting trace 221 can be controlled to adjust the phase of the antenna phase shifter.

In some embodiments, when the first part 11 of the first rotation member 10 rotates clockwise, the pair of first phase-shifting rotation mechanisms 21 meshing with the first part 11 can rotate about the centers of the pair of first phase-shifting rotation mechanisms 21, respectively. Moreover, the rotation directions of the first phase-shifting rotation mechanism 21 can be opposite to each other with a same linear speed.

In the technical solution of the present disclosure, the worm gear-helical gear transmission can be used to drive the antenna phase shifter. Since the worm gear surface also has helical teeth, the first phase-shifting rotation mechanism 21 and the first part 11 of the first rotation member 10 can have the axial force. To maintain the axial position of the first phase-shifting rotation mechanism 21, eliminate the axial force of the first phase-shifting rotation mechanism 21, ensure the transmission precision, and fix the first part 11 of the first rotation member 10, the position-limiting member 30 of the present disclosure can be configured to realize the above purpose.

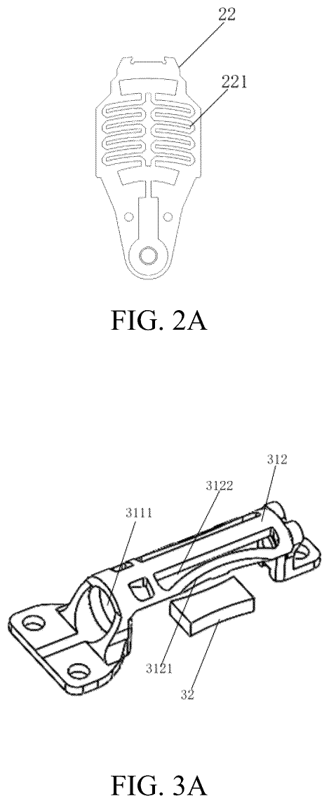

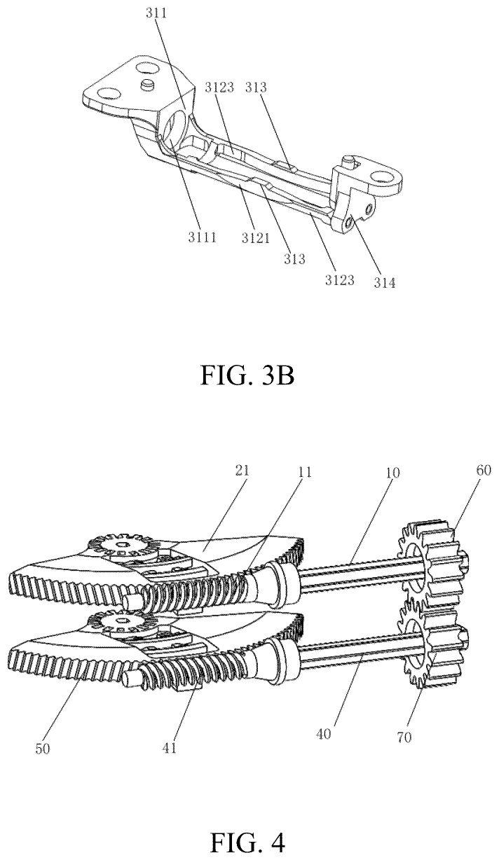

As shown in FIG. 3A and FIG. 3B, in embodiments of the present disclosure, the position-limiting member includes a first position-limiting structure 31 and a second position-limiting structure 32 arranged under the first position-limiting structure 31. In some embodiments, the first position-limiting structure 31 includes a first end 311 and a second end 314 parallel to each other, a sidewall 312 perpendicular to the first end 311 and the second end 314. The part of the first phase-shifting rotation mechanism 21 is arranged between the first position-limiting structure 31 and the second position-limiting structure 32. Thus, the first part 11 of the first rotation member 10 can mesh with the part of the first phase-shifting rotation mechanism 21.

In some embodiments, the first end 311 of the first position-limiting structure 31 can include a first mounting hole 3111. The first part 11 of the first rotation member 10 can be fixed in the first position-limiting structure 31 through the first mounting hole 31111.

In some other embodiments, the first end 311 of the first position-limiting structure 31 can include the first mounting hole 3111, and the second end 314 can include a second mounting hole (not shown in the figure). The first part 11 of the first rotation member 10 can be fixed in the first position-limiting structure 31 through the first mounting hole 31111 and the second mounting hole.

Two side ends 3123 of the sidewall 312 include curved grooves 3121, respectively. A protrusion 313 is provided at a bottom of each curved groove 3121. Each protrusion 313 can correspond to a second position-limiting structure 32 in parallel. Thus, the part of the first phase-shifting rotation mechanism 21 can be arranged between the pair of curved grooves 3121 and the second position-limiting structure 32 with the help of the pair of protrusions 313.

In some embodiments, the sidewall 312 of the first position-limiting structure 31 further includes a hollow structure 3122. The hollow structure 3122 can be configured to improve elasticity of the protrusions 313. Thus, the protrusions 313 can be elastic to facilitate absorbing the tolerance of the manufacturing and assembly to further facilitate the assembly. In addition, the hollow structure 3122 can be further configured to reduce the overall weight of the position-limiting member.

In some embodiments, the curved degree of each curved groove 3121 can be related to the curved degree of the sector-shaped first phase-shifting rotation mechanism 21, such as having substantially the same curved degree (e.g., a difference within +2 degrees or +5 degrees) or having complimentary curved degrees. Thus, the shape of the curved groove 3121 can match the shape of the first phase-shifting rotation mechanism 21 to further improve the position-limiting effect of the position-limiting member.

Thus, with the protrusion 313, the pair of curved grooves 3121, and the second position-limiting structure 32, the axial position of the part of the first phase-shifting rotation mechanism 21 coupled to (e.g., meshing with) the first part 11 of the first rotation member 10.

In the drive apparatus and the phase-shifting assembly of embodiments of the present disclosure, the worm gear and the helical gear can be configured to change the direction of the drive force. In addition, the worm gear-helical gear transmission can achieve a relatively large gear ratio to improve the output force of the antenna phase shifter. When the antenna phase shifter is caused to adjust the phase, the space occupied in the antenna can be reduced, and the structural layout difficulty of the antenna can be reduced. In addition, by using one rotation member to drive two phase-shifting rotation mechanisms simultaneously, the material cost and the process difficulty of the antenna can be reduced, and the production efficiency can be improved.

### Embodiment 2

In some embodiments, the antenna phase shifter is a multi-level phase shifter (for example, the antenna phase shifter includes a plurality of phase-shifting fixed units arranged on different planes and in parallel at intervals, the corresponding movable phase-shifting units, and corresponding phase-shifting rotation mechanisms). As shown in FIG. 4, a two-level antenna phase shifter includes a first phase-shifting rotation mechanism 21 and a second phase-shifting rotation mechanism 50 arranged on different planes and in parallel at intervals, the first phase-shifting fixed unit (not shown in the figure), the first phase-shifting movable unit (not shown in the figure) controlled by the first phase-shifting rotation mechanism 21, the second phase-shifting fixed unit (not shown in the figure), and the second phase-shifting movable unit (not shown in the figure) controlled by the second phase-shifting rotation mechanism 50. In some embodiments, the drive apparatus includes a second rotation member 40, a first transmission part 60, a second transmission part 70, and a second position-limiting member (not shown in the figure).

In some embodiments, the second transmission member 40 can be configured to be coupled to the second phase-shifting rotation mechanism 50 to transfer the drive force of the power mechanism to the second phase-shifting rotation mechanism 50 to drive the second phase-shifting rotation mechanism to move. The first transmission part 60 can be connected to the first rotation member 10. The second transmission part 70 can be coupled to the first transmission part 60 and connected to the corresponding second rotation member 40. The second position-limiting member can be configured to limit a part of the second phase-shifting rotation mechanism 50 in the second position-limiting member.

In some embodiments, the first transmission part 60 and the second transmission part 70 can be gear members. When the power mechanism drives the first rotation member 10 to rotate, the power mechanism can drive the second rotation member 40 to rotate through the coupling movement (e.g., meshing movement) of the first transmission part 60 and the second transmission part 70. The second position-limiting member can be configured to limit the movement of the second phase-shifting rotation mechanism 50 in the axial direction of the second phase-shifting rotation mechanism 50 and limit the axial position of the first part 41 of the second rotation member 40 to ensure that the first part 41 of the second rotation member 40 to drive the corresponding second phase-shifting rotation mechanism 50 to move.

In some embodiments, the first part 41 of the second rotation member 40 can be a worm gear structure. A gear member can be arranged at an edge of the second phase-shifting rotation mechanism 50. Thus, the first part 41 of the second rotation member 40 can mesh with the gear member of the second phase-shifting rotation mechanism 50.

The structure and function of the second position-limiting member of embodiments of the present disclosure can be similar to the structure and function of the position-limiting member 30 of embodiments of the present disclosure, which are not repeated here.

In addition, the phase-shifting assembly of embodiments of the present disclosure can include two or more second phase-shifting fixed units arranged at different planes, the corresponding second phase-shifting movable units, and the second phase-shifting rotation mechanism. A second fixed phase-shifting trace can be provided at a second phase-shifting fixed unit. A second movable phase-shifting trace can be provided at a second phase-shifting movable unit. Thus, the power mechanism can first drive the first rotation member 10 to rotate. Then, the power mechanism can control the relative movement of the first phase-shifting fixed unit and the first phase-shifting movable unit and the relative movement of the corresponding second phase-shifting fixed unit and the second phase-shifting movable unit through the coupled movement of the first transmission part 60 and the second transmission part 70. The power mechanism can also drive the relative movement of the corresponding second phase-shifting fixed unit and the second phase-shifting movable unit through the coupled movement or two neighboring second transmission parts 70.

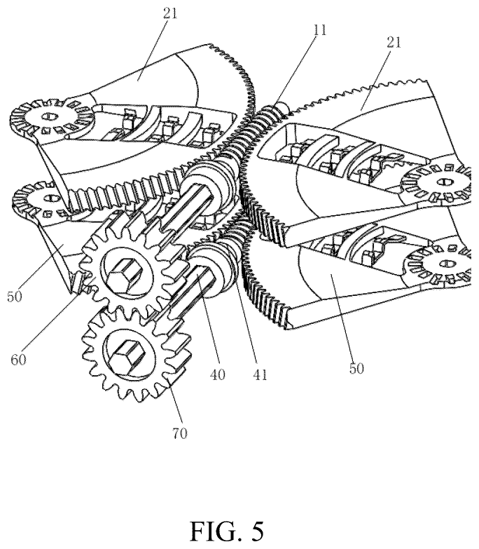

As shown in FIG. 5, when the antenna phase shifter includes two first phase-shifting rotation mechanisms 21 arranged on the same plane and two second phase-shifting rotation mechanisms 50 arranged on the same plane, the power mechanism can drive the pair of first phase-shifting rotation mechanisms 21 to rotate simultaneously through the first rotation member 10. Moreover, the power mechanism can also drive the pair of second phase-shifting rotation mechanisms 50 to perform planar rotation simultaneously through the second rotation member 40.

In addition, in some embodiments, when the first part 11 of the first rotation member 10 and the first part 41 of the second rotation member 40 are double-start worms, the gear members of the pair of the first phase-shifting rotation mechanisms 21 can be symmetrically arranged on the same plane, and the gear members of the pair of the second phase-shifting rotation mechanisms 50 can be symmetrically arranged on another plane. When the first part 11 of the first rotation member 10 and the first part 41 of the second rotation member 40 are single-start worms, the gear members of the pair of first phase-shifting rotation mechanisms 21 can be arranged on the same plane with an offset of n+1/2 tooth pitches (n=0, 1, 2, . . . ), and the gear members of the pair of second phase-shifting rotation mechanisms 50 can be arranged on another plane with an offset of n+1/2 tooth pitches (n=0, 1, 2, . . . ).

In some embodiments, to ensure that the plurality of phase-shifting units in a same row rotate simultaneously and have the same speed, the first part 11 of the first rotation member 10 can have a worm gear structure with a first helical diction, the first part 41 of the second rotation member 40 neighboring to the first rotation member 10 can have a worm gear structure with a helical direction opposite to the first helical direction. When two or more phase-shifting units are provided in the same column, the first parts 41 of the two neighboring second rotation members 40 can have worm gear structures with opposite helical directions.

The phase-shifting assembly of the present disclosure can use the power mechanism to drive the multi-level antenna phase shifter on the same side or in the same column and simultaneously realize the phase-shifting function in the same direction. Thus, the phase-shifting efficiency can be improved, and the manufacturing cost can be reduced.

### Embodiment 3

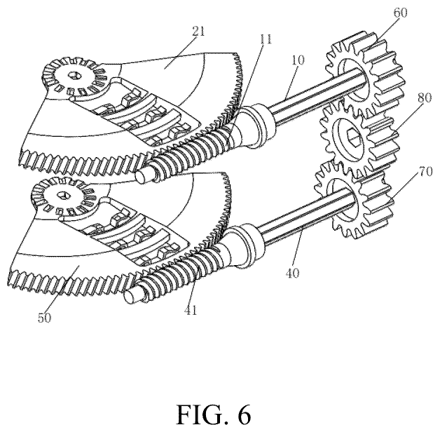

As shown in FIG. 6, the phase-shifting assembly is similar as the phase-shifting assembly shown in FIG. 4. Thus, the same basic structure is not repeated here. The difference includes that, in the phase-shifting assembly shown in FIG. 6, the drive apparatus further includes a third transmission part 80 (e.g., a gear in embodiments of the present disclosure). The third transmission part 80 can be arranged between the first transmission part 60 and the second transmission part 70 as an idle gear. The third transmission part 80 can be configured to cause the first rotation member 10 and the corresponding second rotation member 40 to have the same rotation direction.

Similarly, when the same column of the phase-shifting assembly includes two or more second rotation members 40 and a plurality of second phase-shifting rotation mechanisms 50, the third transmission part 80 can be arranged between neighboring second transmission parts 70. Thus, when the power mechanism drives the first rotation member 10 to rotate, the power mechanism can drive the first phase-shifting rotation mechanism 21 and the corresponding second phase-shifting rotation mechanism 50 to move through the coupled movement of the first transmission part 60, the third transmission part 80, and the second transmission part 70. Meanwhile, the corresponding two second phase-shifting rotation mechanisms 50 can be caused to move through the coupled movement of the two neighboring second transmission parts 70 and the third transmission part 80 therebetween.

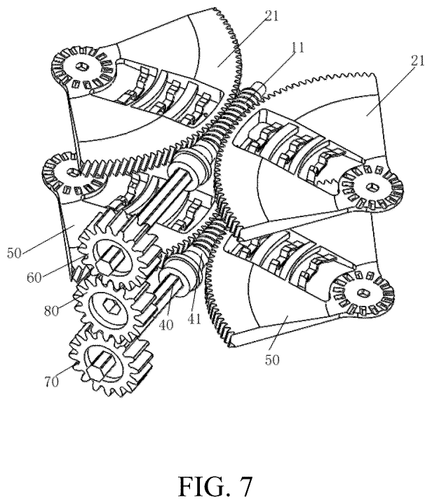

As shown in FIG. 7, the phase-shifting assembly is similar to the phase-shifting assembly shown in FIG. 5. Thus, the same basic structure is not repeated here. The difference can include that, in the phase-shifting assembly shown in FIG. 7, the drive apparatus further includes the third transmission part 80 (e.g., a gear of embodiments of the present disclosure). The third transmission member 80 can be arranged between the first transmission part 60 and the second transmission part 70 as idle gear. Thus, the first rotation member 10 and the corresponding second rotation member 40 can have the same rotation direction.

In some embodiments, since the first rotation member 10 and the one or more second rotation members 40 have the same rotation direction, the first parts of the rotation members having the same rotation direction can cause the first phase-shifting rotation mechanism and the one or more second phase-shifting rotation mechanisms on the same side to have the same rotation direction.

The phase-shifting assembly of embodiments of the present disclosure can use the idle gear to realize the phase-shifting function in the same direction as the multi-level antenna phase shifter on the same side or same column. Thus, the phase-shifting efficiency can be improved, and the manufacturing cost can be reduced.

### Embodiment 4

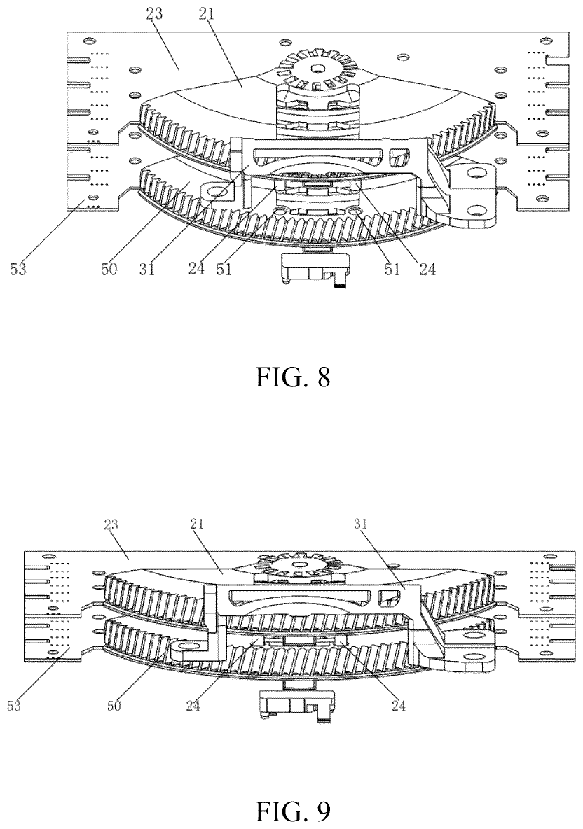

As shown in FIG. 8 and FIG. 9, the phase-shifting assembly of embodiments of the present disclosure includes an antenna phase shifter and a drive apparatus. In some embodiments, the antenna phase shifter includes a first phase-shifting fixed unit, a first phase-shifting movable unit, a first phase-shifting rotation mechanism 21, a second phase-shifting fixed unit, a second phase-shifting movable unit, and a second phase-shifting rotation mechanism 50. The first phase-shifting fixed unit can include a first fixed phase-shifting trace (not shown in the figure). The second phase-shifting fixed unit 53 can include a second fixed phase-shifting trace (not shown in the figure) and a matching hole 51. The second phase-shifting movable unit can include a second movable phase-shifting trace (not shown in the figure). The drive apparatus can include the power mechanism (not shown in the figure) configured to provide the drive force to the antenna phase shifter, a first rotation member (not shown in the figure) connected to the power mechanism, a position-limiting member, and a first drive element 24.

The position-limiting member of embodiments of the present disclosure includes a first position-limiting structure 31. The first position-limiting structure can have the same structure and the principle of the first position-limiting structure above, which is not repeated here. In some embodiments, the first phase-shifting rotation member 21 and the second phase-shifting rotation member 50 can limit the positions of each other. The combination of the first position-limiting structure and the second position-limiting structure can only be used to limit the position of at least one of the first phase-shifting rotation mechanism 21 and the second phase-shifting rotation mechanism 50.

In some embodiments, the first phase-shifting rotation mechanism 21 and the second phase-shifting rotation mechanism 50 can match with each other and be fixed by each other through the pair of first drive elements 24 and the pair of matching holes 51. When the first rotation member transfer the drive force of the power mechanism to the first phase-shifting rotation mechanism 21 to control the relative movement between the corresponding first phase-shifting fixed unit and the first phase-shifting movable unit, the first drive element 24 can directly or indirectly drive the corresponding second phase-shifting rotation mechanism 50 to control the relative movement of the corresponding second phase-shifting fixed unit and the second phase-shifting movable unit.

When the antenna phase shifter includes two or more second phase-shifting fixed units in the same column, the second drive element (not shown in the figure) can be arranged at the bottom of the second phase-shifting fixed unit. Thus, the two neighboring second phase-shifting fixed units can be fixed through the matching between the second drive element and the matching hole.

In some other embodiments, the first drive element 24 and the second drive element can be formed integrally. Thus, the at least one drive element can drive the plurality of phase-shifting rotation mechanisms on the same column.

The above are merely some embodiments of the present disclosure and are not used to limit embodiments of the present disclosure. For those skilled in the art, various modifications and changes can be made to embodiments of the present disclosure. Any modifications, equivalent replacements, and improvements made within the spirit and principle of embodiments of the present disclosure are within the scope of embodiments of the present disclosure.

Although embodiments of the present disclosure are described in detail with reference to specific embodiments. It should be noted that, embodiments of the present disclosure are not used to limit specific embodiments of the present disclosure. Embodiments of the present disclosure are intended to include various modifications and equivalent arrangements within the spirit and scope of the appended claims. The scope of the appended claims is subject to the broadest description and includes the modifications and equivalent structures and functions.

What is claimed is:

1. A phase shifter assembly comprising:
an antenna phase shifter including:
at least one first phase-shifting fixed unit having a first fixed phase-shifting trace;
at least one first phase-shifting movable unit having a first movable phase-shifting trace, the first fixed phase-shifting trace and the first movable phase-shifting trace being in contact with each other; and
at least one first phase-shifting rotation mechanism, each coupled to one of the at least one first phase-shifting movable unit and configured to control a relative movement between the first fixed phase-shifting trace and the first movable phase-shifting trace; and
a drive apparatus including:
a power mechanism configured to provide a drive force to the antenna phase shifter;
a first rotation member connected to the power mechanism and coupled to the at least one first phase-shifting rotation mechanism; and
a position-limiting member configured to limit a movement of the first phase-shifting rotation mechanism in an axial direction of the first phase-shifting rotation mechanism;
wherein the first rotation member transfers the drive force of the power mechanism to the first phase-shifting rotation mechanism to control a relative movement between the first fixed phase-shifting trace and the first movable phase-shifting trace.

2. The phase shifter assembly according to claim 1, wherein when the power mechanism drives the first rotation member to rotate, the position-limiting member is further configured to limit a movement of a first part of the first rotation member in an axial direction of the first rotation member.

3. The phase shifter assembly according to claim 1, wherein the antenna phase shifter includes two first phase-shifting rotation mechanisms arranged in a same plane, the first rotation member is arranged between the two first phase-shifting rotation mechanisms and coupled to the two first phase-shifting rotation mechanisms, respectively, and a part of each first phase-shifting rotation mechanism is arranged in the position-limiting member.

4. The phase shifter assembly according to claim 3, wherein the first part of the first rotation member is an double-start worm, the antenna phase shifter includes two first phase-shifting rotation mechanisms symmetrically arranged in a same plane, and each first phase-shifting rotation mechanism includes a gear member to cause the first part of the first rotation member to respectively mesh with gear members of the two first phase-shifting rotation mechanisms.

5. The phase shifter assembly according to claim 3, wherein the first part of the first rotation member is a single-start worm:
the antenna phase shifter includes two first phase-shifting rotation mechanisms arranged in a same plane; and
each first phase-shifting rotation mechanism includes a gear member;
wherein the gear members of the two first phase-shifting rotation mechanisms are offset by n+1/2 tooth pitches, n being an integer equal to or greater than 0, to cause the first part of the first rotation member to respectively mesh with the gear members of the two first phase-shifting rotation mechanisms.

6. The phase shifter assembly according to claim 1, wherein the antenna phase shifter also includes a first number of second phase-shifting fixed units, a first number of second phase-shifting movable units, and a first number of second phase-shifting rotation mechanisms arranged at an interval with the first phase-shifting fixed unit along an axial direction of the first phase-shifting fixed unit, the drive apparatus further includes:
a first number of second rotation members each coupled to one of the second phase-shifting rotation mechanisms;
a first transmission part connected to the first rotation member;
a first number of second transmission parts, each second transmission part being connected to a corresponding second rotation member, and each second transmission part being coupled to at least one of the first transmission part or a neighboring second transmission part; and
a first number of second position-limiting members, each second position-limiting member being configured to limit a movement of a corresponding second phase-shifting rotation mechanism in an axial direction of the second phase-shifting rotation mechanism, and a part of the second phase-shifting rotation mechanism being arranged in the second position-limiting member;
wherein:
when the power mechanism drives the first rotation member to rotate, the power mechanism controls a relative movement between the first phase-shifting fixed unit and the first phase-shifting movable unit and a relative movement between the corresponding second phase-shifting fixed unit and the second phase-shifting movable unit through a coupled movement of the first transmission part and the second transmission part; and
when the first number is greater than or equal to 2, a relative movement between the corresponding second phase-shifting fixed unit and the second phase-shifting movable unit is controlled through a coupled movement of two neighboring second transmission parts.

7. The phase shifter assembly according to claim 6, wherein when the power mechanism drives the second rotation member to rotate, the second position-limiting member is further configured to limit a movement of the first part of the second rotation member in an axial direction of the second rotation member.

8. The phase shifter assembly according to claim 7, wherein:
the first part of the first rotation member is a worm gear structure with a first helical direction;
a first part of the second rotation member neighboring to the first rotation member is a worm gear structure with a helical direction opposite to the first helical direction;
when the first number is greater than or equal to 2, first parts of the two neighboring second rotation members have worm gear structures with opposite helical directions;
the first phase-shifting rotation mechanism includes a first gear member, and the second phase-shifting rotation member includes a second gear member; and
the first part of the first rotation member meshes with the first gear member, and the first part of the second rotation member meshes with the second gear member of the second phase-shifting rotation mechanism.

9. The phase shifter assembly according to claim 1, wherein the antenna phase shifter further includes a first number of second phase-shifting fixed units, the first number of second phase-shifting movable units, and a second phase-shifting rotation mechanism arranged at intervals with the first phase-shifting fixed unit along an axial direction of the first phase-shifting fixed unit, the drive apparatus further includes:
the first number of second rotation members each coupled to one of the second phase-shifting mechanisms;
a first transmission part connected to the first rotation member;
the first number of second transmission parts, each second transmission part being connected to a corresponding second rotation member;
at least one third transmission part arranged between the first transmission part and the second transmission part to cause the first rotation member and the corresponding second rotation member to have a same rotation direction, or between two neighboring second transmission parts to cause the two neighboring rotation members to have a same rotation direction; and
the first number of second position-limiting members, each second position-limiting member being configured to limit a movement of the corresponding second phase-shifting rotation mechanism in an axial direction of the second phase-shifting rotation mechanism, a part of the second phase-shifting rotation mechanism being arranged in the second position-limiting member;
wherein:
when the power mechanism drives the first rotation member to rotate, the power mechanism controls a relative movement between the first phase-shifting fixed unit and the first phase-shifting movable unit and a relative movement between the corresponding second phase-shifting fixed unit and the second phase-shifting movable unit; and
when the first number is greater than or equal to 2, a relative movement between the corresponding second phase-shifting fixed unit and the second phase-shifting movable unit is controlled by a coupled movement between two neighboring second transmission parts and the third transmission part between the two neighboring second transmission parts.

10. The phase shifter assembly according to claim 9, wherein:
the first part of the first rotation member and a first part of the second rotation member include worm gear structures with a same helical direction; and
the first phase-shifting rotation mechanism includes a first gear member, and a second phase-shifting rotation mechanism includes a second gear member;
the first part of the first rotation member meshes with the first gear member, and the first part of the second rotation member meshes with the second gear member.

11. The phase shifter assembly according to claim 6, wherein:
each second phase-shifting fixed unit includes a second fixed phase-shifting trace;
each second phase-shifting fixed unit includes a second movable phase-shifting trace; and
each second phase-shifting rotation mechanism is configured to control a relative movement between the corresponding second fixed phase-shifting trace and the corresponding second movable phase-shifting trace.

12. The phase shifter assembly according to claim 11, wherein:
the second phase-shifting movable unit is integrally formed with the corresponding second phase rotation mechanism; and/or
the first phase-shifting movable unit is integrally formed with the first phase-shifting rotation mechanism.

13. The phase shifter assembly according to claim 1, wherein the antenna phase shifter further includes a first number of second phase-shifting fixed units, the first number of second phase-shifting movable units, and the first number of second phase-shifting rotation mechanisms:
when the first number is 1, the drive apparatus further includes:
a first drive element connected to a corresponding first phase-shifting rotation mechanism and a second phase-shifting rotation mechanism;
wherein the first rotation member transfers a drive force of the power mechanism to the at least first phase-shifting rotation mechanism to control a relative movement between the corresponding first phase-shifting fixed unit and the first phase-shifting movable unit, and the first drive element controls the relative movement between the corresponding second phase-shifting fixed unit and the second phase-shifting movable unit by driving the second phase-shifting rotation mechanism directly or indirectly; and
when the first number is greater than or equal to 2, the drive apparatus further includes:
the first drive element connected to the corresponding first phase-shifting rotation mechanism and the corresponding second phase-shifting rotation mechanism; and
at least one second drive element connected between two neighboring second phase-shifting fixed units;
wherein when the first rotation member transfers the driving force of the power mechanism to the at least one first phase-shifting rotation mechanism to control the relative movement between the first phase-shifting fixed unit and the first phase-shifting movable unit, the first drive element and the second drive element drive corresponding second phase-shifting rotation mechanisms, respectively, to control a relative movement between the corresponding second phase-shifting fixed unit and the second phase-shifting movable unit.

14. The phase shifter assembly according to claim 13, wherein:
each second phase-shifting fixed unit includes a second fixed phase-shifting trace, and each second phase-shifting fixed unit includes a second movable phase-shifting trace; and
each second phase-shifting rotation mechanism is configured to control a relative movement between the corresponding second fixed phase-shifting trace and the second movable phase-shifting trace.

15. The phase shifter assembly according to claim 14, wherein the second phase-shifting movable unit is integrally formed with the corresponding second phase-shifting rotation mechanism; and/or the first phase-shifting movable unit is integrally formed with the first phase-shifting rotation mechanism.

16. The phase shifter assembly according to claim 1, wherein the position-limiting member or the second position-limiting member includes:
a first position-limiting structure including a first end and a second end parallel to each other, and a sidewall perpendicular to the first end and the second end;
a second position-limiting structure arranged under the first position-limiting structure;
wherein the first part of the first rotation member or the first part of the second rotation member is arranged within the first position-limiting structure, and
a part of the first phase-shifting rotation mechanism is arranged between the first position-limiting structure and the second position-limiting structure to cause the first part of the first rotation member to mesh with the part of the first phase-shifting rotation mechanism; or a part of the second phase-shifting rotation mechanism is arranged between the first position-limiting structure and the second position-limiting structure to cause the first part of the second rotation member to mesh with the part of the second phase-shifting rotation mechanism.

17. The phase shifter assembly according to claim 16, wherein the first end of the first position-limiting structure includes a first installation hole, and the first part of the first rotation member is fixed within the first position-limiting structure through the first installation hole.

18. The phase shifter assembly according to claim 17, wherein the sidewall of the first position-limiting structure also includes a hollow structure configured to enhance elasticity of a protrusion.

19. The phase shifter assembly according to claim 17, wherein:
the sidewall includes a protrusion, and the protrusion is aligned with the second position-limiting structure in parallel to arrange a part of the first phase-shifting rotation mechanism or a part of the second phase-shifting rotation mechanism between the second position-limiting structure with a pair of protrusions.

20. The phase shifter assembly according to claim 13, wherein the position-limiting member includes:
a first position-limiting structure including a first end and a second end that are parallel to each other, and a sidewall perpendicular to the first end and the second end;
wherein:
the first end includes a first installation hole to cause the first part of the first rotation member to be fixed in the first position-limiting structure through the first installation hole; and
the sidewall includes a protrusion aligned with a second position-limiting structure in parallel to cause a part of the first phase-shifting rotation mechanism to be arranged between the second position-limiting structures with the pair of protrusions.
